(19) United States
(12) Patent Application Publication
(10) Pub. No.: US 2004/0162392 A1
(43) Pub. Date: Aug. 19, 2004

(54) Thermoplastic resin composition

(76) Inventors: Michihiro Kaai, Toyoake-shi (JP); Madoka Furuta, Nagoya-shi (JP)

Correspondence Address: Johnson Polymer, Patent Section-MS 509, P O Box 902, 8310 16th Street, Sturtevant, WI, 53177-0902, US

(21) Appl. No.: 10/480,123

(22) PCT Filed: Jun. 7, 2002
(86) PCT No.: PCT/JP02/05660

(30) Foreign Application Priority Data
Jun. 12, 2001 (JP) 2001-177378

(51) Int. Cl. C08L 33/02

(52) U.S. Cl. 525/221; 525/231

(57) ABSTRACT

A thermoplastic resin composition which has high plasticization effect and excellent flexibility. It comprises a polymer and a thermoplastic resin. The polymer comprises at least 20 wt. % of at least one monomer unit represented by any of the following formulae (1) to (4) and up to 80 wt %. of another monomer unit. The resin may be a polymethyl methacrylate resin, poly(vinyl chloride) resin, ABS resin, etc.

CH₂═CHCOO(CH₂CH₂O)ₘ—R (1)

CH₂═C(CH₃)COO(CH₂CH₂O)ₘ—R (2)

CH₂═CHCOO(CH₂C(CH₃)HO)ₘ—R (3)

CH₂═C(CH₃)COO(CH₂C(CH₃)HO)ₘ—R (4)

In the chemical formulae (1) to (4), m is 1, 2 or 3 and R represents hydrogen or C₁₋₄ alkyl.

### TECHNICAL FIELD

The present invention relates to a thermoplastic resin composition which has good flexibility. In particular, the invention relates to improvement of composition which comprises a resin, for example, polymethyl methacrylate resin, poly(vinyl chloride) resin and acrylonitrile-butadiene-stylene copolymer resin (hereinafter referred to as “ABS resin”).

### BACKGROUND ART

When a composition containing a common plasticizer such as dioctyl phthalate (DOP) or the like is molded, problems can occur for example, decrease in the elasticity and flexibility of the moldings or surface tackiness of the molded products. In view of the problems, the improvements to the compositions have been disclosed as shown below.

Japanese Laid-Open Patent Publication 55-160045 discloses a composition for improving processability of poly(vinyl chloride) resin. The composition comprises 2 kinds of polymer components. The first polymer component is obtained by polymerization reaction within a mixture which contains: (meth)acrylate at 0.1-10 wt. %; another alkyl acrylate at 20-99.9 wt. %; and vinyl monomer capable of copolymerization with these at 79.9-1 wt. %. The (meth)acrylate has glycidyl group, hydroxyl group or alkoxy group. The second polymer component is obtained by polymerization reaction within a mixture which contains: methyl methacrylate at 50-100 wt. %; and another vinyl monomer capable of copolymerization with the methyl methacrylate.

A thermoplastic resin in which a specific copolymer is mixed into polycarbonate resin is also known (Japanese Laid-Open Patent Publication 2000-178432). The specific copolymer is obtained by carrying out copolymerization reaction in a component comprising: a first (meth)acrylate ester at 0.1-10 wt. %; a second (meth)acrylate ester at 5-90 wt. %; aromatic vinyl compound at 5-70 wt. %; and another component capable of copolymerization with these at 0-50 wt. %. The first (meth)acrylate ester has epoxy group, hydroxyl group or alkoxy group.

However in the disclosure above, the composition used for improving processability of poly(vinyl chloride) resin did not have sufficient compatibility with the poly(vinyl chloride) resin. In addition, in the above described thermoplastic resin composition, the compatibility was insufficient between the polycarbonate resin and the specific copolymer added to it. Accordingly, the use of the composition was limited in some applications due to low plasticizing effect and inferior flexibility.

The present invention was made in view of the above described problems in the prior art. An object of the invention is to provide a thermoplastic resin composition which has high plasticizing effect and good flexibility.

### DISCLOSURE OF THE INVENTION

In order to achieve the above described object, the composition and the product obtained from the composition comprises a polymer and a thermoplastic resin. In one embodiment the polymer contains a monomer unit represented by any one of formulae (1) through (4) at 20 wt. % or more and another monomer unit at 80 wt. % or less.

CH₂═CHCOO(CH₂CH₂O)ₘ—R (1)

CH₂═C(CH₃)COO(CH₂CH₂O)ₘ—R (2)

CH₂═CHCOO(CH₂C(CH₃) HO)ₘ—R (3)

CH₂═C(CH₃)COO(CH₂C(CH₃)HO)ₘ—R (4)

In equations (1)-(4), m is 1, 2 or 3. R represents hydrogen atom or alkyl group having 1-4 carbons. Here, a combination of m=1 and R being hydrogen atom is excluded.

In one embodiment, the above described monomer has a low weight average molecular weight in a range between 500 and 10,000.

In one embodiment, the composition of the invention contains the polymer in an amount between 10 parts by weight and 200 parts by weight with respect to the thermoplastic resin 100 parts by weight.

In one embodiment of the composition according to the invention, the thermoplastic resin is polymethyl methacrylate resin. In another embodiment, the thermoplastic resin is poly(vinyl chloride) resin. In still another embodiment, the thermoplastic resin is acrylonitrile-butadiene-stylene copolymer resin. In still further embodiment, the thermoplastic resin is AXS resin. AXS resin is a resin obtained by copolymerization of: acrylonitrile; rubber component excluding butadiene; and styrene.

The thermoplastic resin composition has an elongation percentage larger than that of the thermoplastic resin, preferably by 30% or higher, more preferably by 50% or higher and further preferably by 70% or higher. The thermoplastic resin composition has an elongation percentage larger than that of a composition in which only the above described polymer was omitted from the components constituting the thermoplastic resin composition (hereinafter referred to as “composition without the polymer”), preferably by 30% or higher, more preferably 50% or higher and further preferably 70% or higher. The values “30%,” “50%,” and “70%” do not represent increase in the percentage of the elongation with respect to that of the thermoplastic resin or the composition without the polymer. It represents an absolute value of increase in the elongation percentage, calculated by subtracting the elongation value of either the thermoplastic resin or the elongation value of “the composition without the polymer” from the elongation of the thermoplastic resin composition.

### BEST MODE FOR CARRYING OUT THE INVENTION

Embodiments of the invention are described in detail below.

The thermoplastic resin composition comprises the specific polymer and the thermoplastic resin. The polymer comprises the first monomer unit and the second monomer unit distinguishable from the first monomer unit. In other words, the first monomer unit and the second monomer unit are units which form the polymer. The first monomer unit is represented by any one of equations (1) to (4) shown below and is contained in the polymer at 20 wt. % or more. The second monomer unit is contained in the polymer at 80 wt. % or less.

CH₂═CHCOO(CH₂CH₂O)ₘ—R (1)

CH₂═C(CH₃)COO(CH₂CH₂O)ₘ—R (2)

CH₂═CHCOO(CH₂C(CH₃)HO)ₘ—R (3)

CH₂═C(CH₃)COO(CH₂C(CH₃)HO)ₘ—R (4)

In equations (1)-(4), m is 1, 2 or 3. R represents hydrogen atom or alkyl group having 1-4 carbons. Here, a combination of m=1 and R being hydrogen atom is excluded.

In equations (1) through (4), R is preferably an alkyl group having carbon number 1 to 4. In this case, the compatibility of the polymer and the resin is improved so that the plasticizing effect can be enhanced and the flexibility can be improved.

The polymer is obtained by polymerizing alkoxyalkyl (meth)acrylate, which is a monomer having a formula of one of (1) to (4), and another monomer. Examples of the monomer which can be a material for the polymer are shown below in detail for illustrative purpose. For a monomer having formula (1), methoxyethyl acrylate, ethoxyethyl acrylate and butoxyethyl acrylate can be used. For a monomer having formula (2), methoxyethyl methacrylate, ethoxyethyl methacrylate and buthoxyethyl methacrylate can be used. For a monomer having formula (3), methoxyisopropyl acrylate, ethoxyisopropyl acrylate and buthoxyisopropyl acrylate can be used. For a monomer having formula (4), methoxyisopropyl methacrylate, ethoxyisopropyl methacrylate and buthoxyisopropyl methacrylate can be used. A particularly preferable monomer is methoxyethyl (meth)acrylate or ethoxyethyl (meth)acrylate and the most preferred monomer is methoxyethyl acrylate. Another monomer to be polymerized with alkoxyalkyl (meth)acrylate can be any monomer capable of copolymerization with a monomer represented by one of formulae (1) to (4). For example, methyl (meth)acrylate, ethyl (meth)acrylate, propyl (meth)acrylate, butyl (meth)acrylate, 2-ethylhexyl (meth)acrylate, cyclohexyl (meth)acrylate, (meth)acrylic acid, hydroxyethyl (meth)acrylate, hydroxypropyl (meth)acrylate, hydroxybutyl (meth)acrylate, glycidyl (meth)acrylate, vinyl acetate and styrene can be used. Through the specification, the term “(meth)acrylic” is a generic term which can include both acrylic and methacrylic.

The polymer contains the first monomer unit at 20 wt. % or more and the second monomer unit at 80 wt. % or less. If the first monomer unit is contained less than 20 wt. %, in other words, the second monomer unit exceeds 80 wt. %, a composition having high plasticizing effect and excellent flexibility cannot be obtained.

The weight average molecular weight of the polymer is preferably low in a range between 500 and 10,000. If the weight average molecular weight of the polymer exceeds 10,000, the plasticizing effect of the polymer tend to decrease. On the other hand, the low weight average molecular weight of the polymer less than 500 can result in difficulty in the production of the polymer.

The amount of the polymer contained within the composition is desirably in a range between 10 and 200 parts by weight with respect to thermoplastic resin 100 parts by weight. If the content of the polymer is less than 10 parts by weight, the plasticizing effect by the polymer tend to decrease. On the other hand, if the content of the polymer exceeds 200 parts by weight, the obtained composition is too soft that shaping of the product can be difficult.

The viscosity of the polymer is preferably 100,000 cP or less, more preferably 50,000 cP or less and most preferably 20,000 cP or less as measured by B-type viscosity meter at 25° C. This is because sufficient plasticizing effect cannot be obtained in some cases when the viscosity is too high. While there is no limitation to the lower limit of the viscosity, the viscosity of polymers in general is 100 cP or more.

Preferably, the polymer has a glass transition point (Tg) of 0° C. or less, more preferably −20° C. or less and most preferably −30° C. or less, as measured by differential scanning calorimetry (DSC). If the glass transition point exceeds 0° C., the plasticizing effect cannot be realized because the polymer can become too hard.

The polymer is obtained preferably by polymerization at a high temperature in a range between 180 and 350° C. By adjusting the polymerization temperature between 180 and 350° C., a polymer having relatively low molecular weight and excellent plasticizing effect is obtained without using polymerization initiator or chain transfer agent. A molded product of the composition in which the polymer is added has an excellent weathering resistance and the problems such as decrease in the strength and such as coloring can be alleviated. When the polymerization temperature is less than 180° C., polymerization initiator or chain transfer agent is necessary in the polymerization so that coloring can occur in the moldings and odor can be generated, as well as the weathering resistance can be inferior. If the polymerization temperature exceeds 350° C., degradation tends to be caused so that coloring in the shaped product can occur.

A preferable polymerization technique for producing the polymer is continuous bulk polymerization or solution polymerization. In particular, continuous polymerization using stirring tank reactor is preferred. Because the molecular weight distribution can be made small by polymerizing at a high temperature, a well-balanced polymer can be obtained in the aspect of the plasticizing effect and reduced surface tackiness of the molded product in which the polymer has been mixed. While the polymerization initiator may be used or may not be used, the concentration is preferably 1 wt. % or less when it is used.

A part of the polymers thus obtained have terminal double bond. The polymer having a terminal double bond has good compatibility when used as the plasticizer and is preferable because the surface tackiness seldom occurs on the molded product with the plasticizer mixed in. The reason for this phenomenon is presumed that the terminal double bond of the polymer has some reaction with other component of the composition.

The proportion of the polymer having terminal double bond is preferably at 20 wt. % or more, and more preferably 40 wt. % or more. The proportion is calculated from: average molecular weight obtained from gel permeation chromatography (GPC); and the double bond concentration obtained from nuclear magnetic resonance spectroscopy (NMR). The average number of the terminal double bond per one molecule of polymer thus calculated (the total number of the terminal double bonds divided by the number of the polymer molecule) is referred to as terminal double bond index.

The above described polymer has plasticizing efficiency of preferably 30-150, more preferably 40-100, further preferably 40-90 and most preferably 40-80. Here, plasticizing efficiency represents an amount of polymer (by part by weight) which provides a Shore hardness (A or D) equivalent to that of the case where dioctyl phthalate (DOP) 50 wt. % is added to the resin to be plasticized. When the value of the plasticizing efficiency is high, the compatibility between the polymer and the resin can be inferior or, the strength and elongation percentage of the shaped product can be small. While small value of the plasticizing efficiency causes no problem, it is generally difficult to produce a polymer that has plasticizing efficiency of less than 30.

In the case where the polymer is used for plasticizing poly(vinyl chloride) resin, the weight average molecular weight of the polymer is preferably 500-4,000, more preferably 500-2,000, and further preferably 500-1,800 due to above described reason. A Q-value of the polymer provided by a method for water tolerance (hereinafter referred to as “Q-value”) is preferably in a range between 11.5 and 16 and more preferably in a range between 12 and 16. The proportion of butyl acrylate unit with respect to the monomer unit which constitutes the polymer is preferably at 60 wt. % or more. Each value described above can cause effect to delay gelation of the composition when shaping the composition, and can cause effect to decrease the maximum torque applied to the composition.

The calculation of Q-value is described in detail below. A sample 0 5 g is extracted into a conical beaker and is dissolved by adding 50 ml acetone. Water is added once at a small amount until white cloud occurs in the dissolved solution. The Q-value is calculated from the equation shown below by using an amount of water (ml) added until generation of white cloud.

Q-value=50(ml)*9.77/(volume (ml) of mixture of acetone and water)+W(ml)*23.5//(volume (ml) of mixture of acetone and water)

Here, W represents an amount (ml) of water added until occurrence of white cloud. The numerical value “9.77” is a value of solubility parameter of acetone (SP value) and the numerical value “23.5” is SP value of water.

On the other hand, when the polymer is used for plasticizing ABS resin or acrylic resin Plastisol, the Q-value of the polymer is preferably between 13.5 and 16.

When the polymer is used for plasticizing sealant, the weight average molecular weight of the polymer is preferably in a range between 500 and 10,000. The sealant which uses the polymer of the invention can be preferably used in the fields of architecture and civil engineering. Further, the polymer can also be used as processing aid of synthetic resin, extender, filler, or the like.

Examples of usable thermoplastic resin contained in the composition in accordance with the invention are described in more detail. The usable resin are: polymethyl methacrylate resin (PMMA resin); poly(vinyl chloride) resin in Plastisol form; acrylonitrile-butadiene-styrene resin (ABS resin); AXS resin; acrylic resin in Plastisol form; urethane resin; olefin resin; polystyrene resin; polycarbonate resin; crystalline polyester resin; and non-crystalline polyester resin, etc. Among these, polymethyl methacrylate resin, poly(vinyl chloride) resin, ABS resin and AXS resin are preferable for excellent compatibility with the polymer and enhancement of plasticization.

Through the specification, AXS resin is a resin in which butadiene, which is a rubber component of ABS resin, is replaced by another rubber component other than butadiene. In other words, AXS resin is a copolymerized resin of: acrylonitrile; a rubber component other than butadiene; and styrene. Examples of AXS resin are: ASA resin (also referred to as AAS resin) which contains acrylic rubber for the rubber component; ACS resin which contains chlorinated polyethylene for the rubber component; AES resin which contains ethylene-propylene rubber for the rubber component; a resin containing ethylene-vinylacetate copolymer for the rubber component; and AOS resin containing olefin for the rubber component. Note that in the specification the rubber component of AXS resin is a concept which also includes mixed form of rubber components provided that the rubber components are other than butadiene.

An example of crystalline polyester resin is polyethylene terephthalate (PET). An example of non-crystalline polyester resin is polyester obtained from: terephthalic acid; and ethylene glycol and cyclohexane dimethanol.

The thermoplastic resin composition of the invention can contain additives such as rubber component, filler, antioxidant, ultraviolet ray absorbent, etc. The examples of rubber component are: acrylic rubber; butadiene rubber; and stylene-butadiene copolymer rubber. The examples of the filler are: calcium carbonate; talc; clay; magnesium hydroxide; and glass fiber. The examples of the antioxidants are: phenol antioxidants such as 3-(3,5-di-t-butyl-4-hydroxyphenyl)propionate and bisphenol A; salicylic acid antioxidants such as 4-t-butyl phenyl salicylate; and benzophenone antioxidants such as 2-oxy-4-methoxybenzophenone.

The usable ultraviolet ray absorbents are: 2-(5-methyl-2-hydroxyphenyl)benzotriazol ultraviolet ray absorbent; oxalic acid ultraviolet ray absorbent such as 2-ethoxy-2′ ethyl oxalic acid bisanhilide; and hindered amine ultraviolet ray absorbent such as bis(2,2,6,6-tetramethyl-4-piperazine)sebacate. Other additive can include: pigment; lubricant agent; processing aid; and forming agent.

### EXAMPLES

The embodiments of the invention are described in further detail by referring to Examples and Comparative Examples. In the Examples below, % represents weight %.

### Production Examples

(Polymer 1)

Ethyl 3-ethoxypropionate was filled in a 500 ml pressurized stirring reactor having an oil jacket. The temperature was set at 245° C. By means of pressure adjuster, the pressure was set at 3.0 MPa (30 kg/cm²) as measured by gauge pressure.

Monomer mixture was continuously supplied from raw material storage tank to the reactor at a constant rate of feed (42 g per minute; retention period of the mixture: 12 minutes) with the pressure of the reactor retained constant. The monomer mixture comprises ethyl acrylate (hereinafter referred to as “EA”) 70 parts by weight, methoxyethyl acrylate (hereinafter referred to as “C1”) 30 parts by weight, methylethyl ketone (hereinafter referred to as “MEK”) 30 parts by weight and di-t-buthyl peroxide 2 parts by weight. Here, EA and C1 are raw material monomers of the polymer, MEK is a solvent, and di-tertially buthyl peroxide is a polymerization initiator.

The reaction liquid was continuously retracted from the outlet of the reactor in an amount equal to the feed of the monomer mixture. The reaction temperature dropped immediately after the starting feed and then the temperature rose due to polymerization reaction heat. By adjusting the oil temperature of the oil jacket, the reaction temperature was maintained at 245° C.

The point at which the temperature stabilized after starting feed of the monomer mixture was the starting point of reaction liquid recovery. The reaction was continued for 154 minutes from the recovery starting point. Unreacted monomers and any volatile component such as solvent, within the reaction liquid, were removed by continuously introducing the recovered liquid into a thin film evaporator under 250° C.and reduced pressure of 30 kPa·s. A liquid resin (polymer 1) of approximately 4,000 g was obtained. The unreacted monomers within the liquid resin was less than 0.5% according to gas chromatography analysis.

The number average molecular weight (hereinafter referred to as “Mn”) of the polymer 1, by polystyrene conversion of the molecular weight obtained from gel permeation chromatography (hereinafter referred to as “GPC”) using tetrahydrofuran solvent, was 1710. The weight average molecular weight (hereinafter referred to as “Mw”) was 2100. The degree of polydispersion was 1.52. The Q-value was 12.7. The terminal double bond index was 0.70. The viscosity as measured by B-type viscometer at 25° C. was 3800 cP.

(Polymers 2-10)

The similar processes as those used in production of the polymer 1 described above were performed except that the composition of the monomer used were altered as shown by Table 1 to obtain polymers 2-10. In Table 1, BA represents butyl acrylate and St, styrene. The symbol “-” denotes that the data was not measured. In each of the obtained polymer, Mw, viscosity and composition were shown in Table 1.

TABLE 1

| | Polymer | Mw | Viscosity | Composition |
|---|---|---|---|---|
| Production | Polymer 1 | 2100 | 3800 | EA/C1 = 70/30 |
| Example | Polymer 2 | 2160 | 1907 | BA/C1 = 70/30 |
| | Polymer 3 | 1290 | 365 | BA/C1 = 70/30 |
| | Polymer 4 | 1960 | 1234 | BA/C1 = 55/45 |
| | Polymer 5 | 1300 | 370 | BA/C1 = 55/45 |
| | Polymer 6 | 2200 | 900 | BA/C1 = 55/45 |
| | Polymer 7 | 1740 | — | BA/C1 = 55/45 |
| | Polymer 8 | 1800 | 560 | BA/C1 = 45/55 |
| | Polymer 9 | 2290 | 1581 | BA/C1 = 30/70 |
| | Polymer 10 | 2040 | — | St/C1 = 10/90 |
| Production | Polymer 11 | 1230 | 2710 | EA = 100 |
| Comparative | Polymer 12 | 2200 | 3400 | EA/BA = 70/30 |
| Examples | Polymer 13 | 2290 | 1907 | EA/BA = 50/50 |
| | Polymer 14 | 2700 | — | BA/C1 = 90/10 |
| | Polymer 15 | 2500 | — | BA/C1 = 85/15 |

### Production Comparative Examples

(Polymer 11)

Methylethyl ketone (hereinafter referred to as “MEK”) is introduced into a 3-liter flask, set within a water bath and having agitator, as a solvent. The temperature was adjusted at 800° C. The monomer liquid is then continuously added into the flask at a constant rate for four hours. The monomer liquid comprises: EA as a monomer, 700 g; mercaptoethanol as a chain transfer agent, 70 g; MEK as a solvent, 200 g; and azobisisobutylonitrile as a polymerization initiator, 30 g. The temperature was kept at 800° C. through the reaction and the reaction liquid was matured for one hour at 80° C. after stopping feed of the monomer liquid.

The reaction liquid obtained was introduced into a thin film evaporator to remove volatile components such as unreacted monomers under 235° C. and reduced pressure of 30 mmHg. A liquid resin (polymer 11) of 980 g was obtained. According to gas chromatography analysis, the unreacted monomers within the liquid resin was less than 0.5%.

The Mn of the polymer 11, by polystyrene conversion of the molecular weight obtained from GPC using tetrahydrofuran solvent, was 680. The Mw was 1230; degree of polydispersion, 1.81; and viscosity as measured by B-type viscometer at 25° C., 2710 cP.

(Polymers 12-15)

The similar processes as those used in production of the polymer 11 described above were performed except that the composition of the monomer used were altered as shown by Table 1 and that ethyl mercaptoacetate was used for chain transfer agent, to obtain polymers 12-15. Mw, viscosity and composition of polymers 12-15 were shown in Table 1. In Table 1, BA represents butyl acrylate and St, styrene.

### Production Examples

(Polymers 16-19)

Polymers 11-16 were produced by approximately similar production method as that of polymer 11 at polymerization temperature of 800° C. The composition of raw material monomers and Mw and viscosity of the generated polymers 16-19 are shown in Table 2.

TABLE 2

| | Polymer | Mw | Viscosity | Composition |
|---|---|---|---|---|
| Production | Polymer 16 | 1700 | 2600 | EA/C1 = 70/30 |
| Examples | Polymer 17 | 2100 | 500 | BA/C1 = 70/30 |
| | Polymer 18 | 2000 | 850 | BA/C1 = 55/45 |
| | Polymer 19 | 2400 | 1500 | BA/C1 = 30/70 |

### Examples 1-21

### Plasticization of Poly(vinyl Chloride) Resin

Polymers 1-7 were used as plasticizers at amounts shown by Table 3. The polymers 1-7 were added to poly(vinyl chloride) resin 100 parts by weight with a heat stabilizer. As the poly(vinyl chloride) resin, a resin having polymerization degree of 1300 (“TS-1300” manufactured by To a Gosei Company, Ltd.) was used. A mixture of calcium stearate (“SZ-100” manufactured by Sakai Kagaku Kabushiki Kaisha) 1.2 parts by weight and zinc stearate (“SZ-2000” manufactured by Sakai Kagaku Kabushiki Kaisha) 0.3 parts by weight was used for the heat stabilizer.

Poly(vinyl chloride) resin, heat stabilizer and plasticizer were mixed and a sheet having 1 mm thickness was manufactured from the kneaded product by means of press-molding machine. Measurements and evaluations were performed with respect to tensile strength, 100% modulus and elongation percentage (%). The results are shown in Table 3.

TABLE 3

| | | Tensile Test Results | | | |
|---|---|---|---|---|---|
| | | | Tensile | 100% | Elongation |
| | | Amount | Strength | Modulus | Percentage |
| | Polymer | (PHR) | (N/mm²) | (N/mm²) | (%) |
| Example 1 | Polymer 1 | 50 | 21.0 | 14.2 | 377 |
| Example 2 | | 65 | 19.7 | 11.1 | 321 |
| Example 3 | | 80 | 15.1 | 7.8 | 292 |
| Example 4 | Polymer 2 | 50 | 23.5 | 17.8 | 269 |
| Example 5 | | 65 | 22.1 | 13.5 | 324 |
| Example 6 | | 80 | 18.4 | 7.8 | 365 |
| Example 7 | Polymer 3 | 50 | 24.8 | 14.9 | 324 |
| Example 8 | | 65 | 18.0 | 6.5 | 384 |
| Example 9 | | 80 | 17.7 | 6.3 | 392 |
| Example 10 | Polymer 4 | 50 | 25.2 | 17.8 | 286 |
| Example 11 | | 65 | 25.0 | 15.1 | 300 |
| Example 12 | | 80 | 19.5 | 8.8 | 357 |
| Example 13 | Polymer 5 | 50 | 24.0 | 12.7 | 343 |
| Example 14 | | 65 | 21.9 | 9.8 | 344 |
| Example 15 | | 80 | 20.0 | 9.4 | 322 |
| Example 16 | Polymer 6 | 50 | 24.2 | 15.6 | 298 |
| Example 17 | | 65 | 20.4 | 10.1 | 327 |
| Example 18 | | 80 | 16.3 | 7.1 | 331 |
| Example 19 | Polymer 7 | 50 | 23.2 | 15.9 | 278 |
| Example 20 | | 65 | 20.7 | 11.0 | 309 |
| Example 21 | | 80 | 17.1 | 7.3 | 342 |

As shown in Table 3, tensile strength, 100% modulus and elongation percentage (%) were good in Examples 1-21. The term “100% modulus” denotes a tensile stress when 100% elongation is applied. The similar tensile test of poly(vinyl chloride) resin as Example 1 was performed except that the polymer 1 was not added, the elongation percentage was 51%.

### Examples 22-31 and Comparative Examples 1-10

### Plasticization of ABS Resin

In Examples 22-31, ABS resin (“Techno ABS 170” of Techno Polymer) and a polymer (polymers 3-5, 7, 10) of an amount shown in Table 4 were mixed and the kneaded product was molded in to a sheet having 2 mm thickness. A similar sheet was manufactured in Comparative Example 1 from ABS resin only and no polymer was added. In Comparative Examples 2-10, similar sheets were manufactured by adding any of polymers 12-15 as shown by Table 4 with respect to ABS resin. Surface hardness (Shore hardness) was measured as well as performing tensile test to these sheets. The results are shown in Table 4. The tensile test was performed by manufacturing a test chip of “Number 1 shape” as defined in JIS K7113 (tensile test). The surface hardness was measured in accordance with JIS K7215 (durometer D-hardness).

TABLE 4

| | | Tensile Test Result | | | | |
|---|---|---|---|---|---|---|
| | | | Tensile | 100% | Elongation | Shore |
| | | Amount | Strength | Modulus | Percentage | Hardness |
| | Polymer | (PHR) | (N/mm²) | (N/mm²) | (%) | D |
| Example 22 | Polymer 3 | 40 | 9.8 | 9.7 | 100 | 59 |
| Example 23 | | 50 | 8.0 | 7.6 | 119 | 52 |
| Example 24 | Polymer 4 | 50 | 8.7 | 8.2 | 114 | 52 |
| Example 25 | Polymer 5 | 50 | 6.4 | 5.9 | 118 | 45 |
| Example 26 | Polymer 7 | 50 | 6.2 | 4.4 | 263 | 47 |
| Example 27 | | 80 | 1.1 | 0.5 | 284 | 3 |
| Example 28 | Polymer 10 | 40 | 14.6 | 11.5 | 148 | — |
| Example 29 | | 50 | 8.9 | 6.8 | 220 | — |
| Example 30 | | 60 | 7.3 | 4.2 | 279 | — |
| Example 31 | Polymer 5 | 100 | 0.1 | 0.1 | 556 | 17 |
| Comparative | None | 0 | 30.0 | — | 23 | 71 |
| Example 1 | | | | | | |
| Comp. Ex. 2 | Polymer 12 | 30 | Unable to evaluate | | — | — |
| Comp. Ex. 3 | | 50 | Unable to evaluate | | — | — |
| Comp. Ex. 4 | Polymer 13 | 30 | Unable to evaluate | | — | — |
| Comp. Ex. 5 | | 40 | 17.7 | — | 3 | — |
| Comp. Ex. 6 | | 50 | 9.8 | — | 2 | — |

| | | | | | |
|---|---|---|---|---|---|
| Comp. Ex. 7 | Polymer 14 | 30 | Unable to evaluate | — | — |
| Comp. Ex. 8 | | 50 | Unable to evaluate | — | — |
| Comp. Ex. 9 | Polymer 15 | 30 | Unable to evaluate | — | — |
| Comp.Ex. 10 | | 50 | Unable to evaluate | — | — |

As shown in Table 4, the moldings of Examples 22-31 using polymers 3-5, 7 or 10 had specifically high elongation percentage, had good 100% modulus, and maintained tensile strength and Shore hardness. Note that the property degraded when the amount of polymer 7 added was 80 parts by weight (Example 27). In contrast, the subject properties were not obtained or evaluation was unable to perform due to inferior compatibility between ABS resin and the polymers in Comparative Examples 1-10.

### Examples 32, 33 and Comparative Example 11

### Plasticization of ABS Resin

As shown by Table 5, ABS resin (“Cycolac EX101” manufactured by Ube Cycon, Ltd.) and polymer (polymer 1 and polymer 8) were mixed and the kneaded product was formed into a sheet having 2 mm thickness. In contrast in Comparative Example 11, a sheet similar to that of Examples 32 and 33 was manufactured by adding polymer 11. Tensile test was performed to these sheets. The results are shown in Table 5.

TABLE 5

| | | Tensile Test Result | | | |
|---|---|---|---|---|---|
| | | | Tensile | 100% | Elongation |
| | | Amount | Strength | modulus | Percentage |
| | Polymer | (PHR) | (N/mm²) | (N/mm²) | (%) |
| Example 32 | Polymer 1 | 50 | 21.6 | 14.1 | 130 |
| Example 33 | Polymer 8 | 50 | 10.5 | 9.5 | 185 |
| Comparative | Polymer 11 | 50 | 19.0 | — | 1 |
| Example 11 | | | | | |

As shown by Table 5, the moldings which used polymers 1 and 8 in Examples 32 and 33 had higher elongation percentage compared to that of Comparative Example 11.

### Examples 34-41

### Plasticization of Polymethyl Methacrylate Resin

Polymer 7 or 9 of 80 parts by weight was mixed as a plasticizer with respect to various polymethyl methacrylate resin 100 parts by weight shown in Table 6. The kneaded product was formed into a sheet having 1 mm thickness. Tensile strength, 100% modulus and elongation percentage were measured on these sheets and evaluation was performed. The results are shown in Table 6.

TABLE 6

| | | | | | Tensile | 100% | |
|---|---|---|---|---|---|---|---|
| | Polymer | | PMMA resin | | Strength | Modulus | Elongation |
| | Type | Amount | Type | Amount | (N/mm²) | (N/mm²) | (%) |
| Example 34 | Polymer 7 | 80 w/t | Delpet | 100 w/t | 4.1 | 5.8 | 160 |
| | | parts | 560F | parts | | | |
| Example 35 | Polymer 7 | 80 w/t | Delpet | 100 w/t | 4.1 | 3.5 | 189 |
| | | parts | 60N | parts | | | |
| Example 36 | Polymer 7 | 80 w/t | Delpet | 100 w/t | 6.5 | 4.7 | 184 |
| | | parts | LP-1 | parts | | | |
| Example 37 | Polymer 9 | 80 w/t | Delpet | 100 w/t | 3.5 | 3.1 | 179 |
| | | parts | 560F | parts | | | |
| Example 38 | Polymer 9 | 80 w/t | Delpet | 100 w/t | 3.3 | 2.5 | 180 |
| | | parts | 60N | parts | | | |
| Example 39 | Polymer 9 | 80 w/t | Delpet | 100 w/t | 5.6 | 4.4 | 194 |
| | | parts | LP-1 | parts | | | |
| Example 40 | Polymer 9 | 80 w/t | Acrypet | 100 w/t | 7.2 | 3.8 | 236 |
| | | parts | IR H70 | parts | | | |
| Example 41 | Polymer 9 | 80 w/t | Acrypet | 100 w/t | 7.2 | 4.0 | 223 |
| | | parts | MF001 | parts | | | |

As shown in Table 6, good results were obtained in tensile strength, 100% modulus and elongation percentage in Examples 34-41.

### Examples 42-47 and Comparative Examples 12-14

### Plasticization of Polymethyl Methacrylate Resin

In Examples 42-47, polymer 9 at 80 parts by weight as shown in Table 7 and polymethyl methacrylate resin 100 parts by weight were kneaded and the kneaded product was formed into a sheet having 1 mm thickness. In contrast in Comparative Examples 12-14, similar sheets as Examples 42-47 were manufactured by adding polymer 11 to polymethyl methacrylate resin 100 parts by weight. The appearance and breakability were observed in these sheets. The results are shown in Table 7.

TABLE 7

| | Polymer | | PMMA Resin | | | |
|---|---|---|---|---|---|---|
| | | Amount | | Amount | | |
| | | (w/t | | (w/t | | |
| | Type | parts) | Type | parts) | Appearance | Breakability |
| Example 42 | Polymer | 80 | Delpet | 100 | Transparent | ◯ |
| | 9 | | 560F | | | |
| Example 43 | Polymer | 80 | Delpet | 100 | Transparent | ◯ |
| | 9 | | 60N | | | |
| Example 44 | Polymer | 80 | Delpet | 100 | Transparent | Δ |
| | 9 | | LP-1 | | | |
| Example 45 | Polymer | 80 | Acrypet | 100 | Transparent | Δ |
| | 9 | | IR H30 | | | |
| Example 46 | Polymer | 80 | Acrypet | 100 | Transparent | ◯ |
| | 9 | | IR H70 | | | |
| Example 47 | Polymer | 80 | Acrypet | 100 | Transparent | Δ |
| | 9 | | IR G504 | | | |
| Comparative | Polymer | 80 | Delpet | 100 | Transparent | X |
| Example 12 | 11 | | 560F | | | |
| Comparative | Polymer | 80 | Delpet | 100 | Transparent | X |
| Example 13 | 11 | | 60N | | | |
| Comparative | Polymer | 80 | Delpet | 100 | Obscure | X |
| Example 14 | 11 | | LP-1 | | | |

As shown in Table 7, the moldings of Examples 42-47 have transparent appearance and were hard to break. In contrast, the moldings of Comparative Examples 12-14 easily broke and one of them had obscure appearance. In the column of “Breakability” in Table 7: symbol ◯ denotes that the molding was hard to undergo breakage; symbol Δ, more readily undergone breakage than symbol ◯ but harder than symbol X; and symbol X, easily damaged.

### Examples 48, 49 and Comparative Example 15

### Plasticization of ASA Resin

Polymer 1 or 8 shown in Table 8 at 50 parts by weight used for plasticizer and ASA resin, which is a copolymerized resin of acrylonitrile, styrene and acrylate ester, at 100 parts by weight were kneaded and the kneaded product was formed into a sheet having 1 mm thickness. On the other hand, in Comparative Example 15 a sheet similar to those of Examples 48 and 49 were manufactured for the case where no polymer was added. Tensile strength, 100% modulus and elongation percentage were measured on these sheets for evaluation. The results are shown in Table 8.

TABLE 8

| | | Tensile Test Result | | | |
|---|---|---|---|---|---|
| | | | Tensile | 100% | Elongation |
| | | Amount | Strength | modulus | Percentage |
| | Polymer | (PHR) | (N/mm²) | (N/mm²) | (%) |
| Comparative | None | 0 | 28.2 | — | 55 |
| Example 15 | | | | | |
| Example 48 | Polymer 1 | 50 | 8.0 | 6.2 | 201 |
| Example 49 | Polymer 8 | 50 | 5.0 | 4.6 | 199 |

As shown in Table 8, good results were obtained with tensile strength, 100% modulus and elongation percentage of both of Examples 48 and 49. In contrast, specifically elongation percentage was low in Comparative Example 15 in which no polymer is added to result in inferior result.

### Examples 50-61

### Plasticization of Poly(vinyl Chloride) Resin

The sheets similar to that of Example 1 were molded except that polymers 16-19 were used in place of polymer 1. Measurements and evaluations were performed with respect to tensile strength, 100% modulus and elongation percentage (%). The results are shown in Table 9.

TABLE 9

| | | | Tensile Test Result | | |
|---|---|---|---|---|---|
| | | | Tensile | 100% | Elongation |
| Example | Polymer | | Strength | Modulus | Percentage |
| No. | Type | Amount | (N/mm²) | (N/mm²) | (%) |
| Example 50 | Polymer | 50 | 20.5 | 15.5 | 350 |
| Example 51 | 16 | 65 | 19 | 12.1 | 300 |
| Example 52 | | 80 | 17 | 8 | 280 |
| Example 53 | Polymer | 50 | 24 | 17 | 300 |
| Example 54 | 17 | 65 | 22.5 | 14.5 | 320 |
| Example 55 | | 80 | 19 | 8.5 | 380 |
| Example 56 | Polymer | 50 | 25 | 15 | 320 |
| Example 57 | 18 | 65 | 21 | 10 | 350 |
| Example 58 | | 80 | 17 | 7.5 | 370 |
| Example 59 | Polymer | 50 | 21 | 15 | 300 |
| Example 60 | 19 | 65 | 19 | 8 | 340 |
| Example 61 | | 80 | 16 | 7.5 | 370 |

### Examples 62-67

### Plasticization of ABS Resin

Sheets similar to that of Example 22 were manufactured except that polymers 17, 18 are used in place of polymer 3. Surface hardness (Shore hardness) measurement was performed as well as performing tensile test. The results are shown in Table 10.

TABLE 10

| | | | Tensile Test Result | | |
|---|---|---|---|---|---|
| | | | Tensile | 100% | Elongation |
| Example | Polymer | | Strength | Modulus | Percentage |
| No. | Type | Amount | (N/mm²) | (N/mm²) | (%) |
| Example 62 | Polymer | 40 | 10 | 10 | 150 |
| Example 63 | 17 | 50 | 8.5 | 8 | 140 |
| Example 64 | | 60 | 8 | 7 | 140 |
| Example 65 | Polymer | 40 | 13 | 12 | 200 |
| Example 66 | 18 | 50 | 8 | 6 | 220 |
| Example 67 | | 60 | 6.5 | 5 | 260 |

### Examples 68-73

### Plasticization of Polymethyl Methacrylate (PMMA) Resin

The sheets similar to that of Example 37 were molded except that polymer 19 was used in place of polymer 9 and that the types of PMMA resin were altered as shown by Table 11. In Table 11, Delpet and Acrypet are respectively trade names for polymethyl methacrylate resin manufactured by Asahi Kasei Corporation and Mitsubishi Rayon Corporation. Measurements and evaluations were performed with respect to tensile strength, 100% modulus and elongation percentage (%). The results are shown in Table 11.

TABLE 11

| | Polymer | | PMMA resin | | Tensile Test Result | | |
|---|---|---|---|---|---|---|---|
| | | Amount | | Amount | Tensile | 100% | |
| Example | | (w/t | | (w/t | Strength | Modulus | Elongation |
| No. | Type | parts) | Type | parts) | (N/mm²) | (N/mm²) | (%) |
| Example | Polymer | 80 | Delpet | 100 | 4 | 4 | 200 |
| 68 | 19 | | 560F | | | | |
| Example | Polymer | 80 | Delpet | 100 | 3.5 | 3 | 210 |
| 69 | 19 | | 60N | | | | |
| Example | Polymer | 80 | Delpet | 100 | 6 | 4 | 230 |
| 70 | 19 | | LP-1 | | | | |
| Example | Polymer | 80 | Acrypet | 100 | 7 | 4 | 160 |
| 71 | 19 | | IR H30 | | | | |
| Example | Polymer | 80 | Acrypet | 100 | 7.6 | 4.5 | 220 |
| 72 | 19 | | IR H70 | | | | |
| Example | Polymer | 80 | Acrypet | 100 | 5.5 | 4 | 175 |
| 73 | 19 | | IR G504 | | | | |

It is also possible to perform the above described embodiments with changes shown below.

For example, the polymer can be formed only from any of the monomer unit represented by formulae (1) to (4). Further, the polymer may be a combination of 2 or more of the monomer units represented by formulae (1) to (4), or it may be a polymer comprising similar types of monomer units in which values of m and R of the same formula were varied.

In addition, in some embodiments, a plurality of polymers having various plasticizing effect are prepare in advance and these polymers can be used by appropriately mixing them to be conformal to intended flexibility of the molded product.

1. A thermoplastic resin composition comprising:
a thermoplastic resin; and
a polymer which contains a monomer unit represented by any of formulae (1) to (4) shown below at 20 parts by weight or more,
CH₂═CHCOO(CH₂CH₂O)ₘ—R (1)
CH₂═C(CH₃)COO(CH₂CH₂O)ₘ—R (2)
CH₂═CHCOO(CH₂C (CH₃)HO)ₘ—R (3)
CH₂═C(CH₃)COO(CH₂C(CH₃)HO)ₘ—R (4)
and another monomer unit at 80 parts by weight or less,
wherein in formulae (1) to (4), m is 1, 2 or 3, R is a hydrogen atom or an alkyl group having 1 to 4 carbon atoms, and wherein the combination in which m is 1 and R is hydrogen atom is excluded.

2. A thermoplastic resin composition according to claim 1, wherein weight average molecular weight of the polymer is low in a range between 500 and 10,000.

3. A thermoplastic resin composition according to claim 1 wherein an amount of the polymer contained is in a range between 10 and 200 parts by weight with respect to the thermoplastic resin 100 parts by weight.

4. A thermoplastic resin composition according to any one of claims 1 to 3, wherein the thermoplastic resin is polymethyl methacrylate resin.

5. A thermoplastic resin composition according to any one of claims 1 to 3, wherein the thermoplastic resin is poly(vinyl chloride) resin.

6. A thermoplastic resin composition according to any one of claims 1 to 3, wherein the thermoplastic resin is acrylonitrile-butadiene-styrene copolymer resin.

7. A thermoplastic resin composition according to any one of claims 1 to 3, wherein the thermoplastic resin is a copolymerized resin (AXS resin) of acrylonitrile, a rubber composition other than butadiene and styrene.

8. A thermoplastic resin composition according to any one of claims 1 to 3, wherein the thermoplastic resin composition has a higher elongation percentage by 30% than the elongation percentage of the thermoplastic resin.

9. A molded product produced by using the thermoplastic resin composition according to any one of claims 1 to 3.
